(19) United States
(12) Patent Application Publication
(10) Pub. No.: US 2017/0300866 A1
(43) Pub. Date: Oct. 19, 2017

(54) TRANSFERRING USER RECORDS AMONG SYSTEMS

(71) Applicant: tilr corporation, New York, NY (US)

(72) Inventor: Luke Vigeant, New York City, NY (US)

(21) Appl. No.: 15/491,631

(22) Filed: Apr. 19, 2017

Related U.S. Application Data
(60) Provisional application No. 62/324,822, filed on Apr. 19, 2016.

(51) Int. Cl. G06Q 10/10; H04L 29/08

(52) U.S. Cl. CPC G06Q 10/1053; H04L 67/12

(57) ABSTRACT

A method includes receiving a request for transfer of information associated with a user from a first computing system to a second computing system; retrieving information stored in an existing user record for the user in the first computing system; retrieving information indicative of a record format of user records in the second computing system; formatting the retrieved information according to the record format of the user records in the second computing system; and providing the formatted information to the second computing system, the formatted information for storage in a second user record for the user in the second computing system.

### CLAIM OF PRIORITY

This application claims priority to U.S. Patent Application Ser. No. 62/324,822, filed on Apr. 19, 2016, the entire contents of which are incorporated here by reference.

### BACKGROUND

A user of a computing device can request a network resource to obtain information about an opportunity, such as an employment opportunity, for which he or she believes they are qualified. The network resource can be served to the computing device to provide the user with information and to enable to user to take actions to pursue the opportunity.

### SUMMARY

In an aspect, a method includes receiving a request for transfer of information associated with a user from a first computing system to a second computing system; retrieving information stored in an existing user record for the user in the first computing system; retrieving information indicative of a record format of user records in the second computing system; formatting the retrieved information according to the record format of the user records in the second computing system; and providing the formatted information to the second computing system, the formatted information for storage in a second user record for the user in the second computing system.

Embodiments can include one or more of the following features.

Retrieving the information stored in the existing user record comprises storing the retrieved information in a table. Formatting the retrieved information comprises formatting the information stored in the table.

Formatting the retrieved information comprises identifying a field indicated by the record format that is not present in the existing user record.

The method includes prompting the user for data for the identified field.

Formatting the retrieved information comprises identifying a second attribute of the record format that corresponds to a first attribute of the existing user record. Identifying the second attribute comprises accessing a table storing information indicative of correspondences between first attributes and second attributes.

The second computing system is operated by or on behalf of an employer.

The information stored in the existing user record comprises a qualification attribute.

The information stored in the existing user record comprises information indicative of past employment of the user.

In an aspect, a non-transitory computer readable medium storing instructions for causing a computing system to receive a request for transfer of information associated with a user from a first computing system to a second computing system; retrieve information stored in an existing user record for the user in the first computing system; retrieve information indicative of a record format of user records in the second computing system; format the retrieved information according to the record format of the user records in the second computing system; and provide the formatted information to the second computing system, the formatted information for storage in a second user record for the user in the second computing system.

Embodiments can include one or more of the following features.

Retrieving the information stored in the existing user record comprises storing the retrieved information in a table. Formatting the retrieved information comprises formatting the information stored in the table.

Formatting the retrieved information comprises identifying a field indicated by the record format that is not present in the existing user record. The instructions cause the computing system to the user for data for the identified field.

Formatting the retrieved information comprises identifying a second attribute of the record format that corresponds to a first attribute of the existing user record.

Identifying the second attribute comprises accessing a table storing information indicative of correspondences between first attributes and second attributes.

In an aspect, a computing system includes a processor and a memory, the processor and memory configured to receive a request for transfer of information associated with a user from a first computing system to a second computing system; retrieve information stored in an existing user record for the user in the first computing system; retrieve information indicative of a record format of user records in the second computing system; format the retrieved information according to the record format of the user records in the second computing system; and provide the formatted information to the second computing system, the formatted information for storage in a second user record for the user in the second computing system.

### BRIEF DESCRIPTION OF DRAWINGS

FIG. 1 is a system diagram.

FIG. 2 is a diagram of a database.

FIG. 3 is a flow chart.

### DETAILED DESCRIPTION

We describe here an approach to providing network resources, e.g., web pages, pages of a mobile application, etc., to a user based on attributes associated with the user. A system receives a request associated with one or more attributes and one or more criteria. Responsive to the request, the system queries a database storing user records, each user record associated with a corresponding user, to identify a user record having attributes that match the attributes associated with the received request and satisfying the criteria associated with the received request. The system provides network resources to a user associated with the identified user record, the network resources providing the user with access to information about the request. For example, the network resources provided to the user can provide the user with access to information about the request.

In some examples, the request can be a request for a user possessing one or more qualification attributes associated with an available opportunity for employment, such as skill, tool, or certification attributes associated with the opportunity. In some examples, the request can be a request for a user satisfying one or more criteria associated with the available opportunity, such as a criterion indicative of an employment affiliation of the user, a criterion indicative of a work schedule of the user, or other criteria. The database storing user records can be queried to identify a user record associated with a user possessing the one or more qualification attributes indicated by the request and satisfying the associated criteria. Network resources provided to the user associated with the identified user record can provide the user with access to information about the opportunity.

In some examples, multiple systems can provide network resources to users, e.g., based on the user's employment affiliation. The user record associated with a user can be transferred from one system to another system, e.g., responsive to a change in the user's employment status.

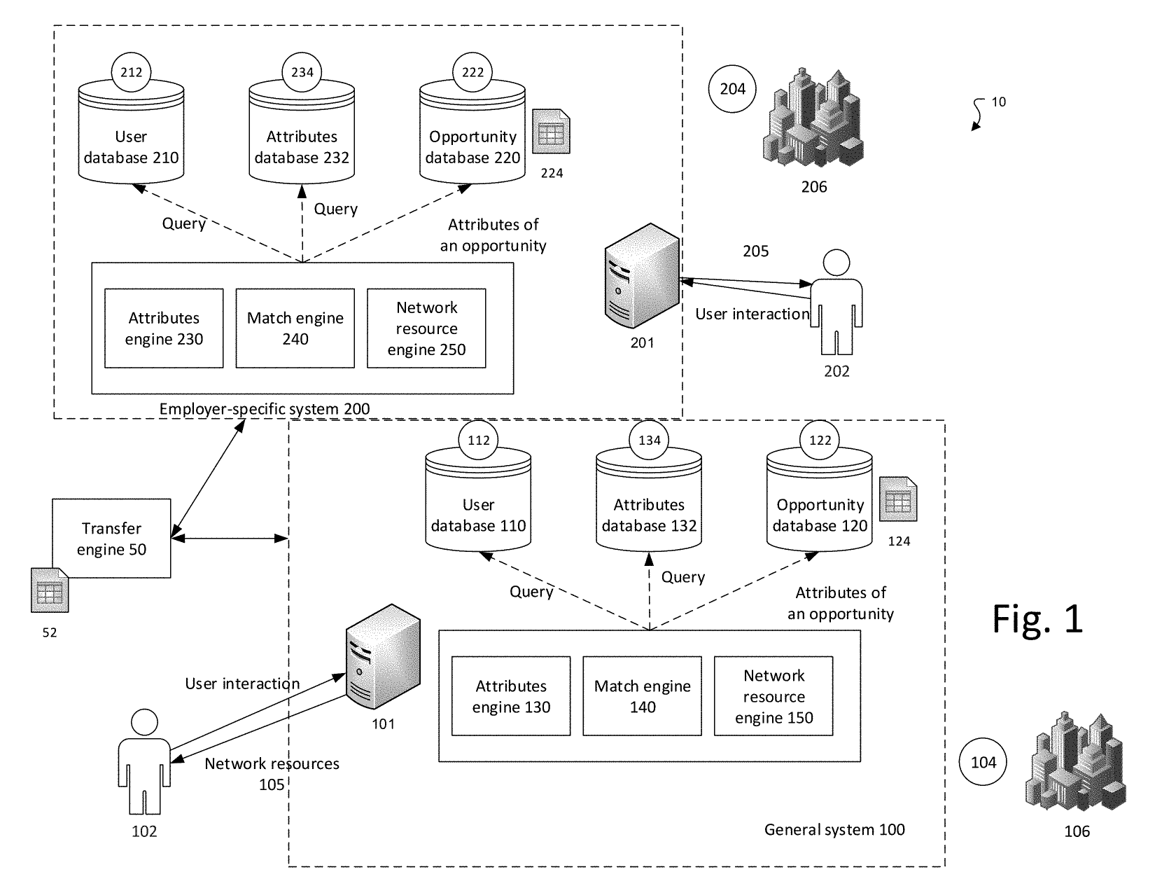

Referring to FIG. 1, a system 10 supports a first system 100 and a second system 200. In the example of FIG. 1, the first system 100, which is implemented by a server 101, enables a user 102 of the system 100 to be provided with network resources 105 associated with an opportunity 104 offered by any of multiple employers 106. We sometimes refer to the system 100 as a public system. The second system 200, which is implemented by a server 201, is an employer-specific system through which an employer 206 can offer opportunities 204 to employees of the employer 206, as discussed further below.

An opportunity 104, for example, is an opportunity for employment with the employer 106 offering the opportunity. Each opportunity 104 represents an employment position (e.g., Barista, Administrative Assistant, Warehouse Clerk, or another position) having a specified schedule. An opportunity 104 can be a one-time occurrence (e.g., a Mail Clerk for Apr. 12, 2016, from 9 am-5 pm), a short-term recurring position (e.g., a Bartender from 6 pm-2 am from Apr. 1, 2016 to Apr. 8, 2016), a long-term recurring position (e.g., a Lifeguard from 10 am-6 pm from Jun. 1, 2016 to Sep. 1, 2016), or a permanent position (e.g., a Legal Secretary from 8 am-5 pm, Monday through Friday, beginning on May 2, 2016).

Each user 102 of the system 100 possesses a set of qualification attributes, such as skill, tool, and/or certification attributes the user has accumulated through education or previous or current employment experience. Each opportunity 104 offered through the system 100 is associated with a set of qualification attributes, such as skill, tool, and/or certification attributes the employer 106 offering the opportunity expects that a person qualified for the opportunity will possess. The system 100 can automatically identify one or more users 102 that are qualified for a particular opportunity 104 based on a match between the qualification attributes (e.g., skill, certification, and/or tool attributes) possessed by each user 102 and the qualification attributes associated with the particular opportunity 104.

The server 101 can serve network resources 105 associated with the particular opportunity 104 to one or more of the users 102 identified as qualified for the opportunity. Through an interaction with the network resources 105, the user 102 can accept the opportunity 104 and complete pre-employment tasks for the opportunity, such as providing information for a background check, providing bank account routing information or tax information, or other tasks. The ability to accept the opportunity and complete related pre-employment tasks without human intervention, such as without intervention by a human resources professional, enables the user to be efficiently assigned to the opportunity and frees human resources professionals at the employer to focus on other tasks.

The server 101 can access a user database 110 that stores a user record 112 for each user 102. The user record 112 for a user 102 can be established upon enrollment of the user 102 with the system 100. The user record 112 for a user 102 can include an identifier of the user's employer, an identifier of a coalition to which the user's employer belongs, or both.

The user record 112 for a particular user 102 can include biographical information about the user 102 (e.g., the user's name, address, e-mail address, phone number, or other biographical information), information about the user's work history, information about the user's educational history, skills possessed by the user, a level of proficiency for each skill, certifications possessed by the user, tools at which the user is proficient, a level of proficiency for each tool, or other information. Information about the user's work history can include titles of jobs previously or currently held by the user, names of previous or current employers, or other information. Information about the user's educational history can include degrees earned by the user, degrees partially completed by the user, coursework completed or in progress, professional certifications, or other information.

In some examples, the user record 112 for a user 102 can include attributes indicative of user preferences, such as location attributes (e.g., indicative of a geographical area the user prefers for his opportunities, a geographical area outside of which the user will not consider opportunities, or other location preferences), schedule attributes (e.g., indicative of preferred days or times for opportunities, days or times the user is unavailable for opportunities, or other schedule preferences), or other preferences. In some examples, the user record 112 can include information about opportunities previously completed by the user, such as the user's rating of a previous opportunity or an employer's rating of a user following completion of a previous opportunity (discussed below).

Some information stored in the user record 112 for a particular user 102 can be entered by the user. For instance, the user 102 can enter biographical information, work history or educational history information, user preferences, or other information. Some information stored in the user record 112 can be determined by the system 100, in conjunction with input from the user. For instance, an attributes engine 130 can identify the qualification attributes (e.g., skill, certification, and/or tool attributes) possessed by the user and/or a level of proficiency associated with each qualification attribute (e.g., the level of proficiency for each skill or tool or the level of a multi-level certification achieved by the user) based on information about the user, such as based on the user's work history or educational history.

Additional description of the attributes engine can be found in co-pending U.S. application Ser. No. [Attorney Docket No. 43032-0002001], the contents of which are incorporated here by reference in their entirety. In some examples, a user can acquire qualification attributes through activities undertaken through the system 100, such as through completion of opportunities or education offered through the system 100. The attributes engine 130 can automatically update a user's user record 112 to reflect the qualification attributes acquired through the system.

An attributes engine 130 implemented by the server 101 can identify one or more qualification attributes that may be possessed by a particular user 102 based on information about the user. For instance, a user may provide information about a previous job, including the title of the position. An attributes database 132 includes job title records 134, each of which includes a job title and an indication of any related job titles (e.g., a pointer to a job title record of each related job title). The attributes engine 130 queries the attributes database 132 to identify one or more job title records 134 that include job titles that are similar or related to the title entered by the user. Each job title record 134 also includes a list of qualification attributes associated with the job title or a reference (e.g., a pointer) to each qualification attribute associated with the job title. The attributes engine 130 identifies a list of the qualification attributes associated with each of the identified job title records 134. The identified qualification attributes are presented to the user via a network resource rendered as a web page (e.g., based on HTML code), a page of a mobile application, or another rendering of the network resource. The user can interact with the network resource to indicate which of the presented qualification attributes (e.g., skills, certifications, or tools) he possesses, and in some cases a level of proficiency associated with each qualification attribute. Based on the user interaction with the network resource, qualification attributes (and, in some cases, a level of proficiency associated with each attribute) are stored in the user record 112.

In an example, if a user enters the title “Admin Assistant,” the attributes engine 130 may query the attributes database 132 to identify the following similar or related job titles: Administrative Assistant, Executive Assistant, Secretary, Office Manager. A list of the qualification attributes associated with one or more of the job titles Administrative Assistant, Executive Assistant, Secretary and Office Manager is presented to the user. The user can then select the skills and certifications he possesses and the tools at which he is proficient from the presented list of qualification attributes, and in some cases can indicate his level of proficiency for each selected skill, certification, and/or tool. The selected skills, certifications, and/or tools are stored as qualification attributes in the user record 112.

The system 100 includes an opportunity database 120 that stores an opportunity record 122 for each available opportunity 104 in the system 100. The opportunity record 122 for a particular opportunity 104 can include the title of the position represented by the opportunity, information about the employer 106 offering the opportunity (e.g., the name of the employer, contact information for the employer, or other information), qualification attributes (e.g., skill, certification, and/or tool attributes) associated with the opportunity, a level of proficiency associated with each qualification attribute, a location attribute for the opportunity, a schedule attribute for the opportunity, a description of the opportunity (e.g., including text, images, video, or other types of data), or other information.

Some information stored in the opportunity record 112 for a particular opportunity 104 offered by an employer 106 can be entered by or on behalf of the employer, such as the title of the position, information about the employer, a location of the opportunity, a schedule for the opportunity, a description of the opportunity, or other information. Some information stored in the opportunity record 112 can be determined by the system 100, in conjunction with input from or on behalf of the employer. For instance, the attributes engine 130 can identify qualification attributes to be associated with the opportunity 104 and/or a level of proficiency associated with each qualification attribute based on information about the opportunity, such as based on the title of the position, as described above.

A match engine 140 identifies one or more users (e.g., the user 102) as qualified for a particular opportunity 104 based on a match between the qualification attributes possessed by the users 102 and the qualification attributes associated with the opportunity 104, according to any rules indicated in the opportunity record 122. For instance, to identify users for a particular opportunity 104, the match engine 140 can query the user database 110 to identify those user records having all of the qualification attributes included in the opportunity record 122 for the particular opportunity 104. In some examples, the opportunity record 122 for the particular opportunity includes a level of proficiency associated with one or more of the qualification attributes, and the match engine 140 can query the user database 110 to identify those user records (e.g., record 112) having all of the qualification attributes included in the opportunity record 122 and having the indicated level for each of one or more of the qualification attributes. We sometimes refer to user records (e.g., record 112) that have all of the qualification attributes included in the opportunity record 122 for a particular opportunity, having the indicated level for each of the one or more qualification attributes, and satisfying any rules indicated in the opportunity record 122 as user records that are matched with the opportunity record.

In some examples, the opportunity record 122 can include rules that indicate a weighting factor for one or more of the qualification attributes included in the opportunity record. The match engine 140 can apply each weighting factor indicated in the opportunity record to the respective qualification attribute in each user record in order to identify user records that are matched with the opportunity record. The weighting factors can enable users that possess particular skills, certifications, and/or tools to be identified.

In some examples, user records (e.g., record 112) identified as matched with an opportunity record are stored in a match table 124 associated with the opportunity record. In some examples, user records 112 identified as matched with an opportunity record can be tracked in another way, such as through a document storing identifiers of the user records or references (e.g., pointers) to the user records.

In some examples, the match engine 140 can identify one or more users for a particular opportunity 104 based on information other than qualification attributes. For instance, the match engine 140 can query the user database 110 to identify those user records (e.g., record 112) having location or schedule attributes that are consistent with the location or schedule attributes for the opportunity.

A network resource engine 150 renders a network resource, such as a web page or a page of a mobile application, for presentation to one or more of the users 102 whose user record (e.g., record 112) was identified by the match engine 140. The network resource can include information about the opportunity 104. Through the network resource, the one or more users 102 are prompted to respond to accept or decline the opportunity 104. When an acceptance is received from a user 102, the user record 112 for the user 102 is updated to reflect that the user 102 is assigned to the opportunity 104. If a user declines the opportunity, the opportunity can be presented to another user.

Additional description of approaches to offering the opportunity to the user and enabling the user to accept and complete the opportunity can be found in co-pending U.S. application Ser. No. [Attorney Docket No. 43023-0003001], the contents of which are incorporated here by reference in their entirety.

The approach of the system 100, in which users are identified as qualified for a particular opportunity based on matching of qualification attributes between the user's user record 112 and the opportunity record 122 for the opportunity, enables qualified users to be offered opportunities even if the opportunity differs from previous jobs the user has held. For instance, a qualified user may be offered an opportunity for a Wait Staff position even if the user has not previously worked as a waiter. Offering opportunities to qualified users enables efficient use of the labor pool of users in the system and helps to provide employment to users and to fill open positions with employers.

The employer-specific system 200 is operated by or on behalf of a particular employer 206, and the role of the employer-specific system is to act as an internal staffing system that enables opportunities 204 offered by the employer 206 to be offered to employees 202 of the employer 206. In some examples, the employer-specific system 200 can be implemented as part of an internal communications network (e.g., an intranet) 205 of the employer 206. The opportunities 204 offered through the employer-specific system 200 are inaccessible to users 102 of the system 100, and conversely the employees 202 of the employer 206 cannot be offered opportunities 104 through the system 100.

Through the employer-specific system 200, an employee 202 (e.g., a permanent or temporary employee, a contractor, or another affiliation) of the employer 206 can be provided with network resources 205 associated with an opportunity 204 associated with the employer 206. Through an interaction with the network resources 205, e.g., provided via an internal communications network of the employer 206, the user 202 can accept the opportunity 204.

The operation of the employer-specific system 200 is generally similar to that of the system 100, described above. The employer-specific system 200 is implemented by a server 201 that is operated by or on behalf of the employer 206. The server 201 can access a user database 210 that stores a user record 212 for each employee 202. The user database 210 can be separate from the user database 110 that forms part of the system 100. The user records 202 can include information such as the information included in the user records 112, described above. For instance, the user record 212 for an employee 202 can include biographical information about the employee, work history or educational history information, employee preferences such as location preferences or schedule preferences, or other information. The employee record 212 can include qualification attributes (e.g., skill, certification, and/or tool attributes) possessed by the employee and/or a level of proficiency associated with each qualification attribute.

In some examples, the qualification attributes and/or level of proficiency for each attribute can be determined by an attributes engine 230 that queries an attributes database 232 that is specific to the system 250 in order to identify potential attributes possessed by an employee. For instance, the attributes database 232 can include job title records 234, each of which includes a job title for a position with the employer 206 and a list of one or more qualification attributes associated with the job title. An attributes database 232 that is specific to the system 250 can enable the employer 206 to define job titles and associated qualification attributes that reflect the qualification attributes that a person is likely to have acquired when working in a position with a particular job title at the employer 206. For instance, the employer 206 can create a job title record 234 for an uncommon job title (e.g., “Cocktail Experience Manager”) that would otherwise be unavailable in the general attributes database 132 of the system 100.

In some examples, the attributes engine 230 can query the attributes database 132 that is part of the system 100. By querying the attributes database 132, the attributes engine 230 can gain access to job title records 134 for common job titles or for job title records 134 that have been accumulated based on the system 100's analysis of large numbers of user records 112 from the general public. In some examples, the attributes engine 230 queries both the attributes database 132 and the attributes database 232.

The employer-specific system 200 includes an opportunity database 220 that stores an opportunity record 222 for each available opportunity 204 offered by the employer 206. The opportunity records 222 can include information such as the information included in the user records 122, described above. For instance, the opportunity record 222 for an opportunity 204 can include the title of the position represented by the opportunity, qualification attributes (e.g., skill, certification, and/or tool attributes) associated with the opportunity, a proficiency level associated with each qualification attribute, a location attribute for the opportunity, a schedule attribute for the opportunity, a description of the opportunity, or other information. In some examples, the qualification attribute and/or proficiency level for each qualification attribute can be determined by the attributes engine, e.g., by querying one or more of the attributes database 132 and the attributes database 232.

A match engine 240 identifies one or more employees (e.g., the employee 202) as qualified for a particular opportunity 204 based on a match between the qualification attributes possessed by the users and the qualification attributes associated with the opportunity 204. The match engine 240 can also identify users based on other information, for instance, by identifying user records having location or schedule attributes that are consistent with the location or schedule for the opportunity. The match engine 240 can apply any rules indicated in the opportunity record 222 for the opportunity in order to identify qualified employees that satisfy the employer's business goals or objectives.

A network resource engine 250 renders a network resource, such as a web page or a page of a mobile application, for presentation to one or more of the employees 202 whose employee record (e.g., record 212) was identified by the match engine 240. The network resource can include information about the opportunity 204. Through the network resource, the one or more employees 202 are prompted to respond to accept or decline the opportunity 204. When an acceptance is received from an employee 204, the employee record 212 for the employee 204 is updated to reflect that the employee 204 is assigned to the opportunity 204. If an employee declines the opportunity, the opportunity can be presented to another employee.

The employer-specific system 200 enables the employer 206 to utilize his labor resources efficiently, for instance, by scheduling qualified employees for shifts in which the employees are available while minimizing the amount of overtime work undertaken by the labor force. The scheduling and staffing capabilities of the employer-specific system 200 can provide a manager with free time to devote to other tasks.

In some examples, a user 102 of the public system 100 may be hired as an employee (e.g., a full time or part time permanent employee, a contractor, or another type of employee) of the employer 206 of the employer-specific system 200. For instance, the user 102 may have previously completed an opportunity 104 at the employer 206 that had been offered through the public system 100, and performed well enough to have been offered a permanent position at the employer 206.

The system 10 can enable the transfer of the data stored in the user's user record 112 in the public system to a new user record 212 for the user in the employer-specific system 200. By transferring these data, any information accumulated about the user during the user's participation with the system 100 can be retained, thus enabling the user to be matched in the future with appropriate opportunities 204 offered through the employer-specific system 200. For instance, any qualification attributes included in the user's user record 112 can be transferred to the new user record 212, thus saving the user from having to undergo a new enrollment process in which he indicates the qualification attributes (e.g., skill, certification, and/or tool attributes) he possesses. User preferences, such as location or schedule attributes, can also be transferred from the user record 112 in the system 100 to the new user record 212 in the system 200, such that the user can be offered opportunities 204 through the system for which he is available.

The system includes a transfer engine 50 that can implement the transfer of information from the user record 112 into a new user record 212 in the system 200. The transfer engine retrieves information from the user record 112 stored in the user database 110 and stores the information in a temporary storage, such as a table 52. The transfer engine 50 also retrieves information about a record format of a new user record 212 created for the user in the user database 210 of the employer-specific system 200. The transfer engine 50 can format the information stored in the table 52 into a format that is compatible with the record format of the new user record 212. The transfer engine 50 can then provide the formatted information from the table 52 to the system 200, where the information is stored into the new user record 212.

In some examples, the record format for the new user record 212 can include one or more fields that are not present in the user record 112 from the system 100. In some cases, the transfer engine 50 can prompt the user for information to complete these fields. In some cases, these fields can be left empty.

In some examples, the employer-specific system 200 may have proprietary information, such as proprietary qualification attributes, that do not necessarily correspond to the attributes used in the system 100 (e.g., the qualification attributes stored in the attributes database 132). In some cases, the transfer engine 50 can identify one or more proprietary qualification attributes corresponding to each of the qualification attributes included in the user record 112. For instance, the transfer engine 50 can refer to data, such as a table, that maps correspondences between the proprietary qualification attributes of the employer-specific system 200 and the qualification attributes of the public system 100. In some cases, the transfer engine 50 can identify one or more proprietary qualification attributes that are similar to each of the qualification attributes included in the user record 112. In some examples, the transfer engine 50 can present the identified proprietary qualification attributes to the user 102, to the employer 206, or both, for confirmation, prior to providing the identified proprietary qualification attributes for storage in the new user record 212.

In some examples, information from a user record (e.g., record 212) in the employer-specific system 200 can be transferred to the public system 100. In some examples, information from a user record (e.g., record 212) in the employer-specific system 200 can be transferred to a different employer-specific system operated by or on behalf of a different employer.

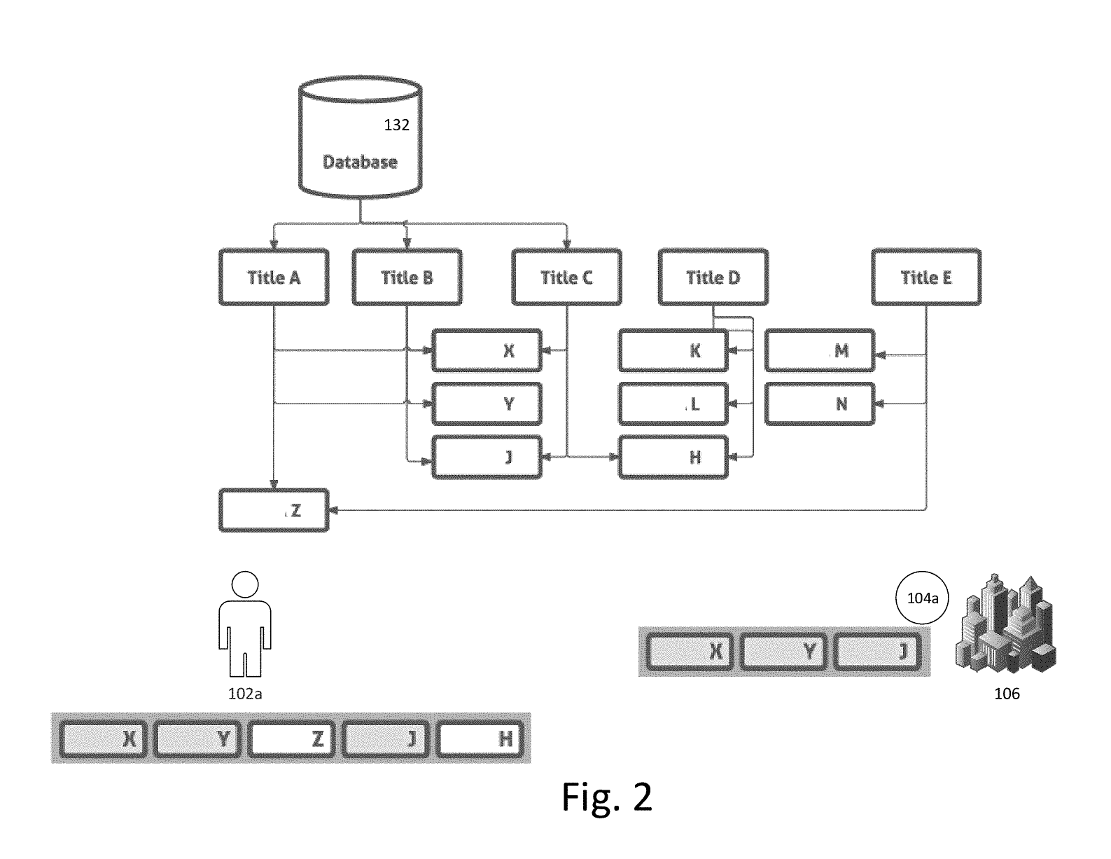

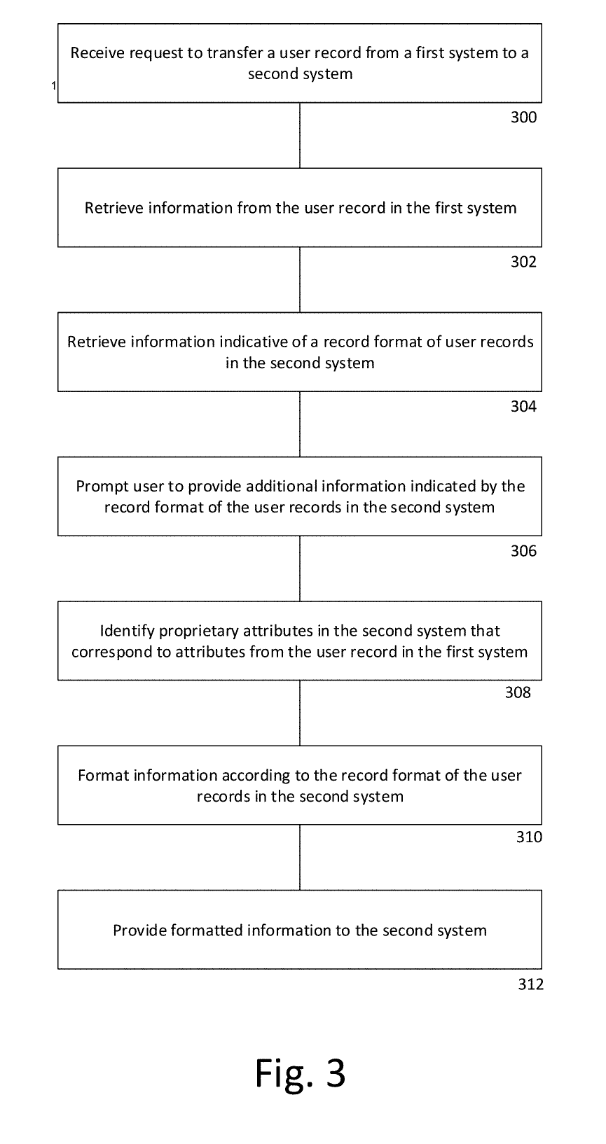

Referring to FIG. 2, in a specific example, the attributes database 132 includes job title records 134 for five job titles: Title A, Title B, Title C, Title D, and Title E. The example of FIG. 3 can similarly depict the attributes database 232 including job title records 234. Each job title record 134 includes references to the qualification attributes associated with the job title of the record. For instance, the job Title A is associated with the qualification attributes X, Y, and Z. The job Title B is associated with the qualification attributes X, Y, and J. The job Title C is associated with the qualification attributes X, J, and H. In a specific example, Titles A, B, and C may be Custodian, Housecleaner, and Gardener, respectively. The qualification attribute X may be “Manual labor,” the qualification attribute Y may be “Cleaning,” the qualification attribute Z may be “Facilities management,” the qualification attribute J may be “Managing client expectations,” and the qualification attribute H may be “Working outdoors.”

In this example, a user 102a has worked in a Title A role (e.g., Custodian) and a Title C role (e.g., Gardener) and has indicated (e.g., during an enrollment process) that he has acquired all of the qualification attributes associated with these two roles. The worker 102a thus possesses the qualification attributes X (Manual labor), Y (Cleaning), Z (Facilities management), J (Managing client expectations), and H (Working outdoors). Although the user has never worked in a Title B role (e.g., Housecleaner), the match engine 140 identifies the user 102a as qualified for an opportunity 104a in a Title B role because the user 102a possesses all of the qualification attributes associated with the Title B role.

In the example of FIG. 2, the user 102a is identified as qualified for the opportunity 104a based on a comparison between the qualification attributes possessed by the user 102a and the qualification attributes associated with the opportunity 104a. In some examples, other criteria can be used in addition to matching of qualification attributes to determine whether the user 102a is to be offered the opportunity 104a. For instance, the user's location or schedule attributes or the user's previous experiences in opportunities offered through the system can be taken into account, e.g., as described above.

Referring to FIG. 3, in an example process, a request to transfer a user record for a user from a first system (e.g., a public system) to a second system (e.g., an employer-specific system) is received (300). For instance, the request can be made because the user is or will become an employee of the employer associated with the employer-specific system. Information from the user record in the first system is retrieved and stored in a temporary storage (302), such as a table. Information indicative of a record format of user records in the second system is retrieved (304). In some examples, the user can be prompted to provide additional information that is indicated in the record format of the user records in the second system, but that is not included in the information retrieved from the user record (306). The additional information is stored in the temporary storage. In some examples, proprietary qualification attributes in the second system are identified that correspond to the qualification attributes from the user record in the first system (308) and stored in the temporary storage. The information stored in the temporary storage, including any additional information provided by the user and any identified proprietary qualification attributes, is formatted according to the record format of the user records in the second system (310). The formatted information is provided to the second system for storage in a new user record for the user (312).

Other implementations are also within the scope of the following claims.

What is claimed is:

1. A method comprising:
receiving a request for transfer of information associated with a user from a first computing system to a second computing system;
retrieving information stored in an existing user record for the user in the first computing system;
retrieving information indicative of a record format of user records in the second computing system;
formatting the retrieved information according to the record format of the user records in the second computing system; and
providing the formatted information to the second computing system, the formatted information for storage in a second user record for the user in the second computing system.

2. The method of claim 1, in which retrieving the information stored in the existing user record comprises storing the retrieved information in a table.

3. The method of claim 2, in which formatting the retrieved information comprises formatting the information stored in the table.

4. The method of claim 1, in which formatting the retrieved information comprises identifying a field indicated by the record format that is not present in the existing user record.

5. The method of claim 4, comprising prompting the user for data for the identified field.

6. The method of claim 1, in which formatting the retrieved information comprises identifying a second attribute of the record format that corresponds to a first attribute of the existing user record.

7. The method of claim 6, in which identifying the second attribute comprises accessing a table storing information indicative of correspondences between first attributes and second attributes.

8. The method of claim 1, in which the second computing system is operated by or on behalf of an employer.

9. The method of claim 1, in which the information stored in the existing user record comprises a qualification attribute.

10. The method of claim 1, in which the information stored in the existing user record comprises information indicative of past employment of the user.

11. A non-transitory computer readable medium storing instructions for causing a computing system to:
receive a request for transfer of information associated with a user from a first computing system to a second computing system;
retrieve information stored in an existing user record for the user in the first computing system;
retrieve information indicative of a record format of user records in the second computing system;
format the retrieved information according to the record format of the user records in the second computing system; and
provide the formatted information to the second computing system, the formatted information for storage in a second user record for the user in the second computing system.

12. The non-transitory computer readable medium of claim 11, in which retrieving the information stored in the existing user record comprises storing the retrieved information in a table.

13. The non-transitory computer readable medium of claim 12, in which formatting the retrieved information comprises formatting the information stored in the table.

14. The non-transitory computer readable medium of claim 11, in which formatting the retrieved information comprises identifying a field indicated by the record format that is not present in the existing user record.

15. The non-transitory computer readable medium of claim 14, storing instructions for causing the computing system to prompt the user for data for the identified field.

16. The non-transitory computer readable medium of claim 11, in which formatting the retrieved information comprises identifying a second attribute of the record format that corresponds to a first attribute of the existing user record.

17. The non-transitory computer readable medium of claim 16, in which identifying the second attribute comprises accessing a table storing information indicative of correspondences between first attributes and second attributes.

18. A computing system comprising:
a processor and a memory, the processor and memory configured to:
receive a request for transfer of information associated with a user from a first computing system to a second computing system;
retrieve information stored in an existing user record for the user in the first computing system;
retrieve information indicative of a record format of user records in the second computing system;
format the retrieved information according to the record format of the user records in the second computing system; and
provide the formatted information to the second computing system, the formatted information for storage in a second user record for the user in the second computing system.
